(19) United States
(12) Patent Application Publication
(10) Pub. No.: US 2018/0352753 A1
(43) Pub. Date: Dec. 13, 2018

(54) Flower pot, method for exchanging decorative cover sleeve of flower pot, and method of assembling flower pot

(71) Applicant: Dwight Ashley Thompson, Moerkapelle (NL)

(72) Inventor: Dwight Ashley Thompson, Moerkapelle (NL)

(21) Appl. No.: 15/773,775

(22) PCT Filed: Nov. 4, 2016
(86) PCT No.: PCT/NL2016/050768

§ 371 Date: May 4, 2018

(30) Foreign Application Priority Data
Nov. 4, 2015 (NL) 2015721

(51) Int. Cl. A01G 9/00; A01G 9/02; A47G 7/08

(52) U.S. Cl. CPC A01G 9/006; A47G 7/085; A01G 9/02

(57) ABSTRACT

This invention relates to a flower pot comprising a bottom, a side wall extending from the bottom of the flower pot, and an exchangeable decorative cover sleeve, wherein the side wall comprises an upper circumferential edge, a lower circumferential edge and a recess in between the upper and lower circumferential edge, and wherein the exchangeable decorative cover sleeve is arranged in the recess to be retained by the upper and lower circumferential edge while allowing to exchange the decorative cover sleeve. The invention further relates to a method for exchanging a decorative cover sleeve of a flower pot according to the invention, and a method to assemble a flower pot according to the invention.

### BACKGROUND OF THE INVENTION

The invention relates to a flower pot, a method for exchanging decorative cover sleeve of such a flower pot, and a method of assembling such a flower pot.

An example of a decorative cover sleeve for flowers and flower pots is disclosed in Dutch patent publication NL1024309 in which the cover sleeve is made of textile. A disadvantage of this cover sleeve is that the sleeve is not able to support its own weight and had to be attached to the flower pot or flower/plant to be kept in a position suitable to cover the flower pot.

Another example of a decorative cover sleeve is disclosed in Dutch patent application NL1034301 in which the cover sleeve comprises a water proof bottom part. However, due to the presence of the water proof bottom part, it is not easy to fit the cover sleeve around a flower pot, especially not when the flower pot is relatively heavy e.g. due to the amount of soil and/or water inside the flower pot.

Yet another example of a decorative cover sleeve is disclosed in US patent publication U.S. Pat. No. 6,108,974 in which a cover sleeve composed of elastic material is provided to be tightly fitted around a flower pot. This flower pot cover sleeve has the same disadvantage of being difficult to be fitted around a flower pot, especially when the flower pot is relatively heavy.

### BRIEF SUMMARY OF THE INVENTION

In view of the above it is an object of the invention to provide an improved flower pot.

According to a first aspect of the invention, the object is achieved by providing a flower pot comprising a bottom, a side wall extending from the bottom of the flower pot, and an exchangeable decorative cover sleeve, wherein the side wall comprises an upper circumferential edge, a lower circumferential edge, and a recess in between the upper and lower circumferential edge, and wherein the exchangeable decorative cover sleeve is arranged in the recess to be retained by the upper and lower circumferential edge while allowing to exchange the decorative cover sleeve.

An advantage of the flower pot according to the first aspect of the invention is that the upper and lower circumferential edges not only retain the decorative cover sleeve, but also cover the upper and lower edges of the decorative cover sleeve which usually have a different undesired appearance then the outer surface when no special measures are taken. These special measures are now not necessary and thus the decorative cover sleeve can be manufactured less expensive. Further, it is not possible to look into a possible gap or slit in between the decorative cover sleeve and the side wall.

A further advantage is that the decorative cover sleeve and flower pot seem to form an integral part in which the decorative cover sleeve is supported by the flower pot, while the decorative cover sleeve is still exchangeable and can be easily applied and removed.

In order to exchange the decorative cover sleeve, the decorative cover sleeve may be deformed, e.g. elastically deformed, to be pulled over one of the upper and lower circumferential edge, preferably over the lower circumferential edge. However, it is also possible that at least one of the two circumferential edges is temporarily removed to allow the decorative cover sleeve to be exchanged.

In a embodiment, the flower pot comprises an upper portion with the upper circumferential edge and a separate lower portion with the lower circumferential edge that are connected to each other. This allows to exchange the decorative cover sleeve by disconnecting the lower and upper portion from each other, introducing the decorative cover sleeve in the recess and connecting the lower and upper portion to each other again. A similar advantage may be obtained when assembling the flower pot for the first time.

In an embodiment, the upper portion comprises the bottom of the flower pot and the lower portion is connected to the bottom of the upper portion. In this way, the connection is not visible for users of the flower pot and the flower pot is still usable when disconnecting the upper and lower portion.

In an embodiment, the lower portion is clamped to the upper portion, preferably the bottom of the upper portion. This allows to easily disconnect the lower portion from the upper portion.

In an embodiment, the lower portion is glued to the upper portion, preferably the bottom of the upper portion. In this way it can be prevented that the lower portion undesirably disconnects from the upper portion.

In an embodiment, the upper circumferential edge is located at a top side of the side wall.

In an embodiment, the lower circumferential edge is located at a bottom side of the side wall.

When the upper circumferential edge is located at a top side and at the same time the lower circumferential edge is located at a bottom side of the side wall, the decorative cover sleeve covers the most of the side wall. It may even look as if the decorative cover sleeve is standing on its own.

In an embodiment, the side wall has a circular cross-section. Preferably, the side wall forms a truncated cone, wherein an area of a cross-section at the bottom is smaller than an area of a cross-section at an upper side of the flower pot. As a result, removing the decorative cover sleeve over the lower circumferential edge becomes easier once a first portion of the decorative cover sleeve has passed the lower circumferential edge, and applying the decorative cover sleeve becomes likewise easier.

In an embodiment, the side wall comprises, on the inside, a shoulder to support an inner pot. This allows to easily introduce a flower or plant including inner pot into the flower pot.

In an embodiment, the upper and/or lower circumferential edges may be provided with a rim to cover, i.e. partially overlap with, the upper and/or lower side of the decorative cover sleeve, respectively. The edge and rim than form a recess to receive the upper or lower side of the decorative cover sleeve. This may cover any frayed edges of the decorative cover sleeve when the decorative cover sleeve is made of cloth and/or may also cover any fabrication tolerances causing a gap or slit between the upper or lower sides of the decorative cover sleeve and the respective circumferential edge.

The invention according to the first aspect of the invention also relates to a method for exchanging a decorative cover sleeve of a flower port according to the first aspect of the invention, wherein the method comprises the following steps:
a) removing the decorative cover sleeve from the recess; and
b) positioning/applying another decorative cover sleeve in the recess.

In an embodiment, the flower pot comprises an upper portion with the upper circumferential edge and a separate lower portion with the lower circumferential edge that are connected to each other, wherein prior to removing the decorative cover sleeve from the recess, the lower portion is disconnected from the upper portion, and wherein after positioning/applying the other decorative cover sleeve in the recess, the lower portion is connected to the upper portion to retain said other decorative cover sleeve.

In an embodiment, the decorative cover sleeve comprises elastic material, wherein removing the decorative cover sleeve from the recess comprises pulling the decorative cover sleeve over one of the upper and lower circumferential edge, preferably the lower circumferential edge.

The invention according to the first aspect of the invention further relates to a method to assemble a flower pot according to the first aspect of the invention comprising the step of positioning the decorative cover sleeve in the recess.

In an embodiment, the flower pot comprises an upper portion with the upper circumferential edge and a separate lower portion with the lower circumferential edge that are connectable to each other, wherein the lower portion is connected to the upper portion after positioning the decorative cover sleeve in the recess.

The object of the invention is also obtained according to a second aspect of the invention by providing a flower pot comprising a bottom, a side wall extending from the bottom of the flower pot, and an exchangeable decorative cover sleeve, wherein preferably the decorative cover sleeve at the bottom side thereof is removeably clamped to the bottom, and wherein the decorative cover sleeve at an upper side thereof is folded over an upper edge of the side wall and removeably clamped on the inside of the flower pot.

An advantage is that the decorative cover sleeve is exchangeable, i.e. can be removed and applied in this case at any moment, and both the upper and lower edges of the decorative cover sleeve, which usually have a different undesired appearance then the outer surface when no special measures are taken, are hidden at the bottom and on the inside of the flower pot. This is especially the case for decorative cover sleeves made of cloth, which may have frayed edges. The frayed edges may be present from the start, but may also occur at a later stage due to handling of the decorative cover sleeve. However, due to the clamping action at the bottom and on the inside of the flower pot, this degrading of the decorative cover sleeve is not visible for a long period of time.

In an embodiment, the upper side of the decorative cover sleeve is clamped on the inside of the flower pot using one or more clamping members.

In an embodiment, the upper side of the decorative cover sleeve is clamped between the inner side of the side wall of the flower pot and a separate removeable ring in the flower pot acting as clamping member. Preferably, the ring comprises one or more gripping members to couple with corresponding recesses or openings in the side wall to retain the ring inside the flower pot. The ring may be resilient to allow deformation of the ring in order to remove the gripping members from the corresponding recesses or openings, thereby removing the ring from the inside of the flower pot.

In an embodiment, the bottom comprises a groove or recess to receive a clamping element to clamp the lower side of the decorative cover sleeve between the clamping element and the bottom.

In an embodiment, the lower side of the decorative cover sleeve is clamped between the inner side of the side wall and a clamping element that also forms the bottom. In that case, the bottom and side wall are not an integral part and the decorative cover sleeve is clamped between the bottom and side wall.

In an embodiment, the side wall has a circular cross-section. The side wall may further form a truncated cone, wherein an area of a cross-section at the bottom side is smaller than an area of a cross-section at an upper side.

In an embodiment, the clamping members on the inside of the flower pot clamping the upper side of the decorative cover sleeve form a support for an inner pot. The ring may for instance form a shoulder to support the inner pot.

In an embodiment, the side wall extends on both sides of the bottom, and the lower side of the decorative cover sleeve is then also clamped on an inside of the side wall, similar to the upper side, but below the bottom of the flower pot. The feature of the second aspect of the invention that the decorative cover sleeve at the bottom side thereof is removeably clamped to the bottom should be interpreted as reading that the decorative cover sleeve at the bottom side thereof is removeably clamped to the lower side of the side wall, e.g. on the inside of the lower side of the side wall.

The invention according to the second aspect of the invention also relates to a method for assembling the flower pot according to the second aspect of the invention, wherein the method comprises the following steps:
a) positioning the decorative cover sleeve around the side wall of the flower pot;
b) folding the upper side of the decorative cover sleeve over an upper edge of the side wall;
c) clamping the upper side of the decorative cover sleeve on the inside of the flower pot; and
d) if applicable, clamping the lower side of the decorative cover sleeve to the bottom of the flower pot.

The invention according to the second aspect of the invention also relates to a method for exchanging the decorative cover sleeve of the flower pot according to the second aspect of the invention, wherein the method comprises:
a) releasing the upper side of the decorative cover sleeve on the inside of the flower pot;
b) if applicable, releasing the lower side of the decorative cover sleeve at the bottom of the flower pot;
c) removing the decorative cover sleeve;
d) assembling another decorative cover sleeve in accordance with the above described assembling method.

It is noted here explicitly that where applicable, features from one aspect of the invention may apply to the other aspect of the invention as well. It is also possible that parts of one aspect of the invention are combined with parts of the other aspect of the invention. For instance, the decorative cover sleeve may be delimited by an upper circumferential edge at the upper side of the decorative cover sleeve in accordance with the first aspect of the invention and may be clamped at the lower side to the bottom in accordance with the second aspect of the invention, or the upper side of the decorative cover sleeve is clamped to the inside of the flower pot in accordance with the second aspect of the invention while the lower side is delimited by a lower circumferential edge in accordance with the first aspect of the invention.

### BRIEF DESCRIPTION OF THE DRAWINGS

The invention will now be described in a non-limiting way with reference to the accompanying drawings in which like parts are indicated by like reference symbols and in which:

FIG. 1 schematically depicts a cross-sectional view of a flower pot according to an embodiment in accordance with the first aspect of the invention;

FIG. 2 depicts an exploded view of the flower pot of FIG. 1;

FIG. 3 depicts a perspective view of a flower pot according to another embodiment in accordance with the second aspect of the invention;

FIG. 4 depicts an exploded view of the flower pot of FIG. 3;

FIG. 5A-D depict various steps in the assembling of the flower pot of FIG. 3 using a method in accordance with the second aspect of the invention; and

FIG. 6 depicts a cross-sectional view of the flower pot of FIG. 3.

### DETAILED DESCRIPTION OF THE INVENTION

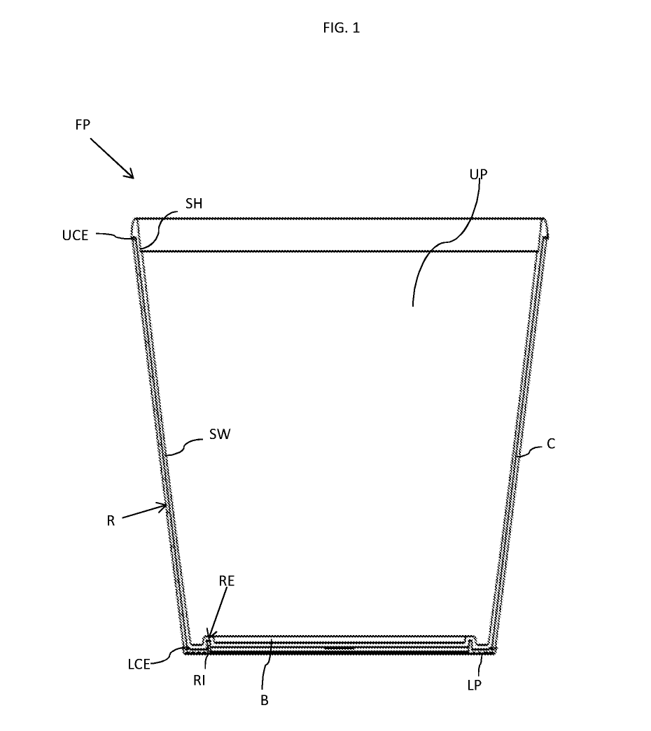

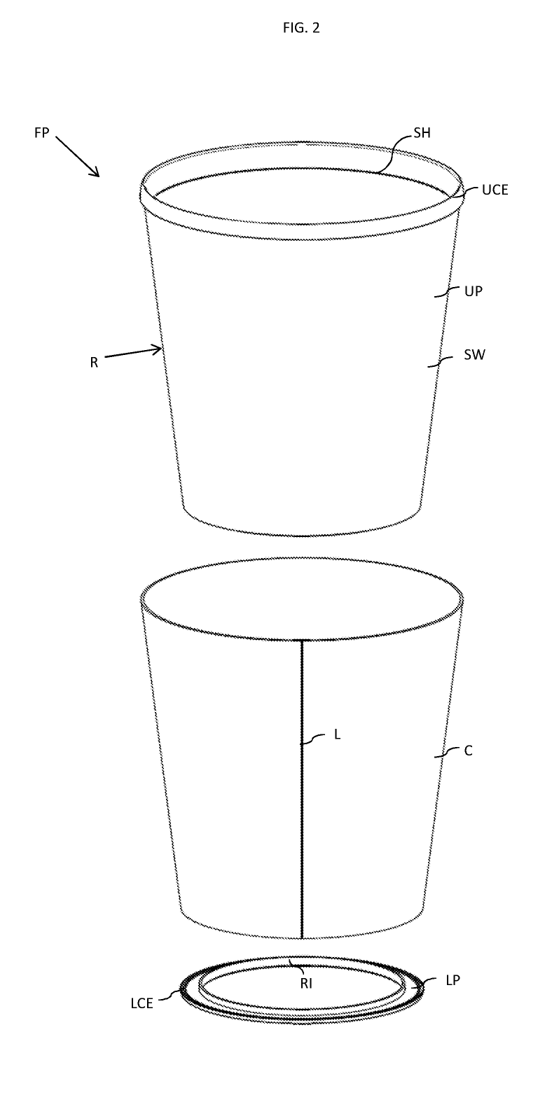

FIGS. 1 and 2 depict a flower pot FP according to an embodiment in accordance with the first aspect of the invention. FIG. 1 depicts a cross-sectional view of the flower pot FP and FIG. 2 depicts an exploded view of the flower pot FP.

The flower pot FP comprises a bottom B and a side wall SW extending from the bottom B of the flower pot FP. The cross-section of the side wall SW in this embodiment is circular, but could be any shape including elliptic and polygons such as a square, rectangle and triangle. The side wall SW in general forms an inverted truncated cone which is smaller at the bottom B than at an upper side of the side wall SW.

The side wall SW comprises an upper circumferential edge UCE at the upper side of the side wall SW, a lower circumferential edge LCE at the bottom B of the side wall SW, and a recess R in between the upper circumferential edge UCE and the lower circumferential edge LCE. The recess R may also be referred to as recessed surface R.

The recess R is able to receive an exchangeable decorative cover sleeve C that is arranged in the recess R and retained by the upper circumferential edge UCE and the lower circumferential edge LCE.

The lower circumferential edge LCE is arranged on a separate lower portion LP, which comprises a ridge RI to be received in a corresponding recess RE of the bottom B of the flower pot FP to be connected to upper portion UP comprising the upper circumferential edge UCE.

The connection between the lower portion LP and the upper portion UP, may be a clamping connection allowing to easily disconnect the two portions UP, LP. Alternatively or additionally, the connection may be a snap connection or a glued connection.

On the inside, the side wall SW comprises a shoulder SH allowing to support a growing pot or other flower holding pot having a smaller height than the flower pot FP in order to prevent the growing pot or other flower holding pot to get stuck in the flower pot between opposite portions of the side wall SW.

An advantage of the embodiment of FIGS. 1 and 2, is that it can easily be assembled. The upper portion UP, decorative cover sleeve C and lower portion LP can be manufactured separately. The decorative cover sleeve C can for instance be made out of a single piece of cloth, leather or other material, where opposite sides can be connected along line L to form a shape that substantially matches the shape of the recess R. The term “substantially” is used as a perfect match is not required or essential, especially in case the decorative cover sleeve comprises elastic material.

Subsequently, the decorative cover sleeve is positioned in the recess R over the upper portion UP until it rests against the upper circumferential edge UCE. This step can easily be performed due to the inverted truncated cone shape of the recess resulting in the decorative cover sleeve engaging with the upper portion only at the last moment. In this step, the advantage of a separate lower portion including lower circumferential edge becomes imminent, as the lower circumferential edge poses no barrier for the decorative cover sleeve while placing the cover C on the upper portion.

Once the decorative cover sleeve is positioned on the upper portion, the cover can be retained on the flower pot by connecting the lower portion to the upper portion at the bottom thereof.

When the cover is to be removed, for instance to be washed or to be replaced by another decorative cover sleeve, the lower portion may be removed prior to removing the cover. However, in case the connection between lower portion and upper portion is more or less permanent, the cover may also be removed by moving it over the lower circumferential edge which is possible when the cover is sufficiently elastic.

Although the embodiment in FIGS. 1 and 2 depicts a flower pot in which the cover C covers substantially the entire height of the flower pot, the invention also covers embodiments in which the cover only covers a part of the externally facing surface of the side wall SW.

Although, in an embodiment, the flower pot comprises an upper portion with the upper circumferential edge and a separate lower portion with the lower circumferential edge that are connected to each other, it is also possible that the flower pot besides the exchangeable decorative cover sleeve is made as a single part and that the cover sleeve can be pulled over the upper and/or lower circumferential edge.

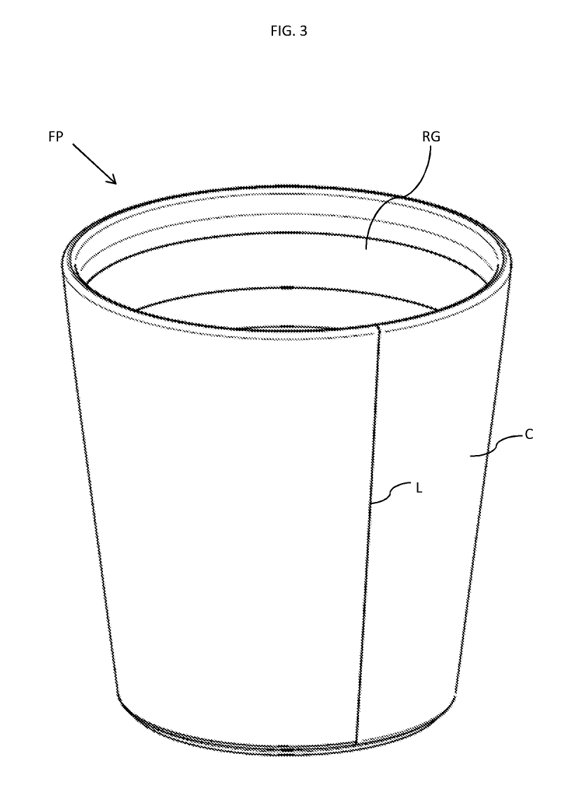

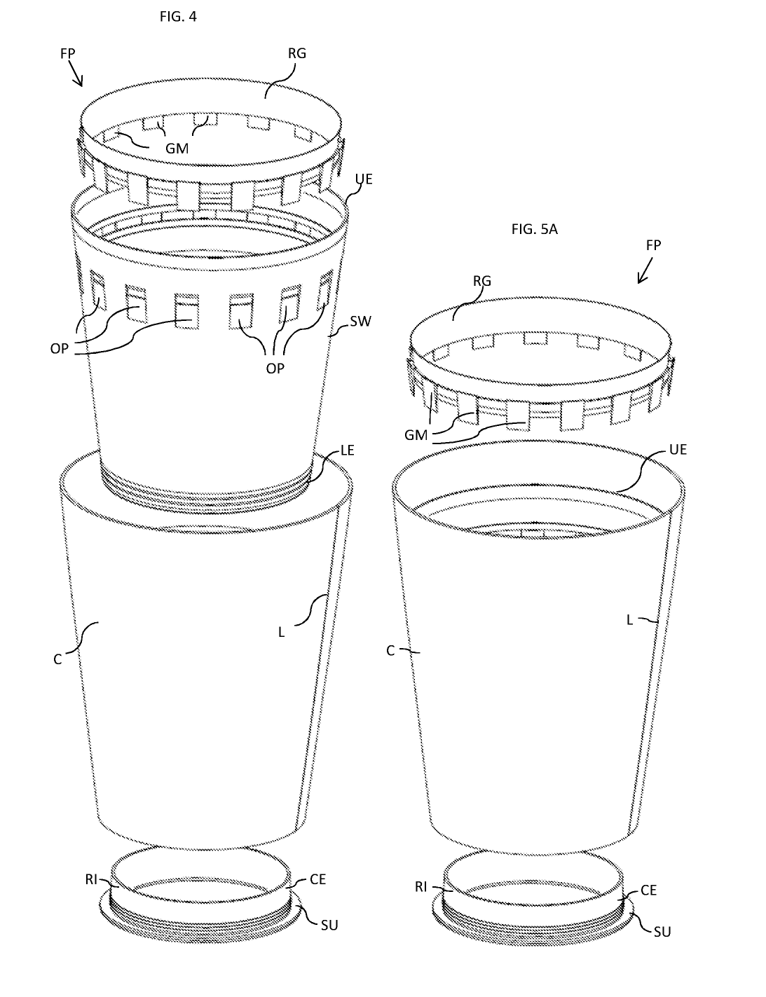

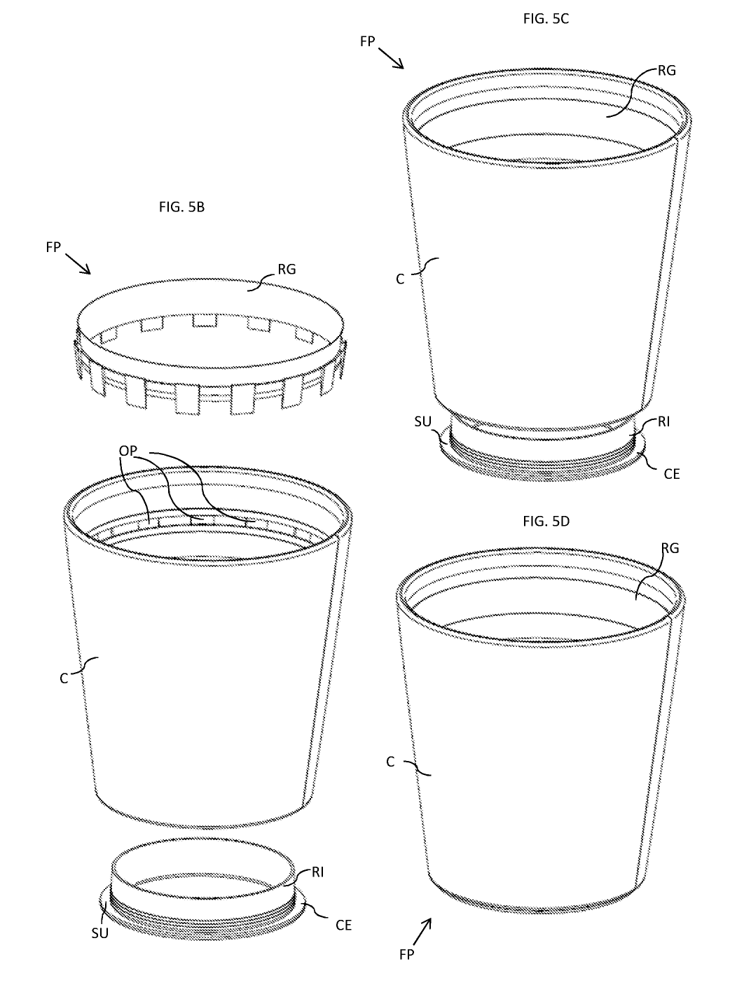

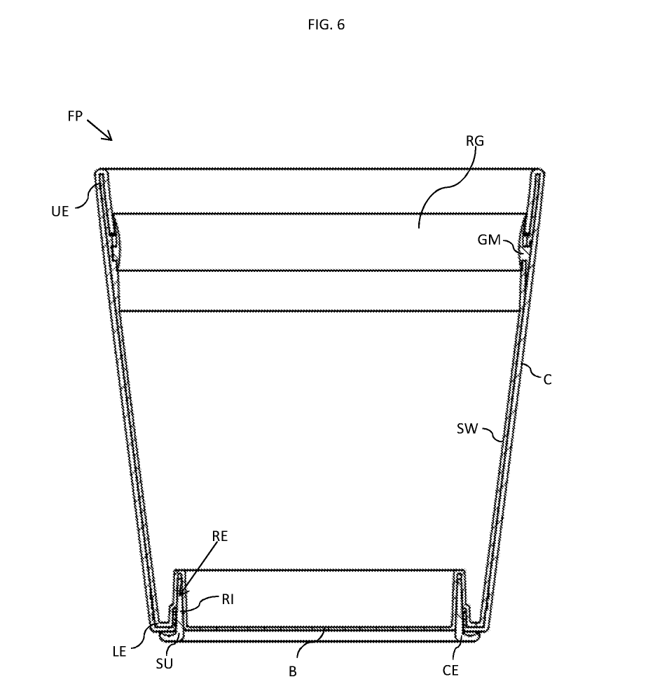

FIGS. 3-6 depict a flower pot FP according another embodiment in accordance with the second aspect of the invention. FIG. 3 depicts a perspective view of the flower pot FP, FIG. 4 depicts an exploded view of the flower pot FP, and FIG. 6 depicts a cross-sectional view of the flower pot FP. FIGS. 5A-5D depict various steps in an assembling method.

As can be best seen in FIGS. 4 and 6, the flower pot comprises a bottom B and a side wall SW extending from the bottom B of the flower pot FP.

To cover the outside of the flower pot FP, a decorative cover sleeve C is provided. A length of the decorative cover sleeve C is larger than a corresponding length of the side wall SW. In other words, the decorative cover sleeve when positioned around the flower pot as shown in FIG. 5A, extends beyond an upper UE and lower LE edge of the flower pot FP.

The decorative cover sleeve C is subsequently folded inwards over the upper edge UE and lower edge LE, respectively.

The bottom B of the flower pot comprises a recess RE allowing to receive the portion of the decorative cover sleeve C that is folded inwards over the lower edge LE and a clamping element CE. Folding the decorative cover sleeve over the lower edge such that the folded portion covers the recess RE is sufficient in this embodiment to introduce the clamping element into the recess RE thereby taking the folded portion of the decorative cover sleeve into the recess RE. This step corresponds to the transition from the situation as depicted in FIG. 5C to the situation as depicted in FIG. 5D.

The clamping element CE in this embodiment comprises a ridge RI to be received in the recess RE of the bottom B in order to apply the clamping force, and a support SU that allows to handle the clamping element during assembly and exchange of the decorative cover sleeve and in order to support the flower pot once the clamping element is introduced into the bottom of the flower pot.

The flower pot FP further comprises a ring RG that can be inserted into the flower pot from above to clamp the portion of the decorative cover sleeve that has been folded over the upper edge on the inside of the flower pot. This step corresponds to the transition from the situation as depicted in FIG. 5B to the situation as depicted in FIG. 5C.

An advantage of folding the decorative cover sleeve around the upper and lower edges of the flower pot is that the upper and lower edges of the decorative cover sleeve, which usually have a different undesired appearance then the outer surface when no special measures are taken, are hidden. This advantage becomes even more apparent when the decorative cover sleeve is made of cloth having frayed edges, which are not always easily covered by circumferential edges as described in accordance with the first aspect of the invention. Clamping the decorative cover sleeve allows the decorative cover sleeve to be easily removed or exchanged.

In this embodiment, the side wall SW of the flower pot FP comprises recesses or openings OP evenly distributed around the circumference of the flower pot FP to mate with corresponding gripping members GM on the ring RG. When introducing the ring RG into the flower pot FP, the gripping members GM are received in the openings OP and retained thereby, e.g. like a snap connection, so that a proper clamping action can be ensured. Removing the ring RG can for instance be done by elastically deforming the ring RG.

Preferably, the ring RG when inserted into the flower pot provides a smooth surface covering the edges of the decorative cover sleeve.

The cross-section of the side wall SW in this embodiment is again circular, but could be any shape including elliptic and polygons such as a square, rectangle and triangle. The side wall SW in general forms an inverted truncated cone which is smaller at the bottom B than at an upper side of the side wall SW which makes it easy to correctly position the decorative cover sleeve C, which has a mating shape, around the flower pot.

The decorative cover sleeve C can for instance be made out of a single piece of cloth, leather or other material, where opposite sides can be connected along line L to form a shape that substantially matches the shape of the side wall SW. The term “substantially” is used as a perfect match is not required or essential, especially in case the decorative cover sleeve comprises elastic material.

1. A flower pot comprising a bottom, a side wall extending from the bottom of the flower pot, and a deformable exchangeable decorative cover sleeve, wherein the side wall comprises an upper circumferential edge, a lower circumferential edge, and a recess in between the upper and lower circumferential edges, and wherein the exchangeable decorative cover sleeve is arranged in the recess to be retained by the upper and lower circumferential edge while allowing to exchange the decorative cover sleeve.

2. A flower pot according to claim 1, wherein the flower pot comprises an upper portion with the upper circumferential edge and a separate lower portion with the lower circumferential edge that are connected to each other.

3. A flower pot according to claim 1, wherein the upper circumferential edge is located at a top side of the side wall.

4. A flower pot according to claim 1, wherein the lower circumferential edge is located at the bottom side of the side wall.

5. A flower pot according to claim 1, wherein the side wall has a circular cross-section.

6. A flower pot according to claim 1, wherein the side wall forms a truncated cone, wherein an area of a cross-section at the bottom is smaller than an area of a cross-section at an upper side of the flower pot.

7. A flower pot according to claim 1, wherein the side wall on the inside comprises a shoulder to support an inner pot.

8. A method for exchanging a decorative cover sleeve of a flower pot according to claim 1, said method comprising the following steps:
a) removing the decorative cover sleeve from the recess; and
b) positioning another decorative cover sleeve in the recess.

9. A method according to claim 8, wherein the flower pot is a flower pot according to claim 2, wherein prior to removing the decorative cover sleeve from the recess, the lower portion is disconnected from the upper portion, and wherein after positioning the other decorative cover sleeve in the recess, the lower portion is connected to the upper portion to retain said other decorative cover sleeve.

10. A method according to claim 8, wherein the decorative cover sleeve comprises elastic material, and wherein removing the decorative cover sleeve from the recess comprises pulling the decorative cover sleeve over the lower circumferential edge.

11-15. (canceled)
